(19) United States
(12) Patent Application Publication
(10) Pub. No.: US 2017/0103676 A1
(43) Pub. Date: Apr. 13, 2017

(54) Cognitive Personalized Nutrition Analysis Based on Image and Sensor Driven Data

(71) Applicant: International Business Machines Corporation, Armonk, NY (US)

(72) Inventors: Corville O. Allen, Morrisville, NC (US); Joseph N. Kozhaya, Morrisville, NC (US)

(21) Appl. No.: 14/878,281

(22) Filed: Oct. 8, 2015

(51) Int. Cl. G09B 19/00; G06K 9/62

(52) U.S. Cl. CPC G09B 19/0092; G06K 9/6267; G06K 2209/17

(57) ABSTRACT

A system, method, and computer-readable medium are disclosed for cognitive personalized nutrition analysis comprising: performing a visual recognition operation to identify ingredients being used by a chef; analyzing sensor data to identify ingredients being used by a chef; determining a cooking style based upon the visual recognition operation and the sensor data; cross referencing ingredients and cooking style to locate potential recipes corresponding to the ingredients and cooking style; and, notifying the chef of identified recipes and possible substitutions.

### BACKGROUND OF THE INVENTION

Field of the Invention

The present invention relates in general to the field of computers and similar technologies, and in particular to software utilized in this field. Still more particularly, it relates to a method, system and computer-usable medium for personalized nutrition analysis based on image and sensor driven data.

Description of the Related Art

It is known to communicate with and control many devices via the Internet. This communication and control is often referred to as the Internet of Things (IoT) and the devices are referred to as IoT devices. The IoT allows devices to be sensed and controlled remotely as well as to provide information based upon the type of IoT device across existing network infrastructure.

### SUMMARY OF THE INVENTION

A method, system and computer-usable medium are disclosed for cognitive personalized nutrition analysis comprising: performing a visual recognition operation to identify ingredients being used by a chef; analyzing sensor data to identify ingredients being used by a chef; determining a cooking style based upon the visual recognition operation and the sensor data; cross referencing ingredients and cooking style to locate potential recipes corresponding to the ingredients and cooking style; and, notifying the chef of identified recipes and possible substitutions.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts an exemplary client computer in which the present invention may be implemented.

FIG. 2 is a simplified block diagram of an information processing environment having many IoT type devices.

FIG. 3 shows a flow chart of a nutritional analysis operation.

### DETAILED DESCRIPTION

A method, system and computer-usable medium are disclosed for leveraging a plurality of Internet of Things devices sensors to identify the contents of a recipe being prepared, highlight potential nutritional concerns and provide cognitive portion and ingredients suggestions via a cognitive portion and ingredient suggestion operation. The cognitive portion and ingredient suggestion operation is performed based on information obtained from the plurality of IoT devices. In certain embodiments, the information obtained includes a cooking process, a cooking style and ingredients used. Also in certain embodiments, the IoT devices include devices capable of sensing visual information. In various embodiments, the cognitive portion and ingredient suggestion operation performs a video recognition analysis operation on the visual information. Additionally, in various embodiments, the cognitive portion and ingredient suggestion operation cross references the information provided by the IoT devices against a recipe system to match a user's personalized profile including nutrition objectives. By utilizing video recognition on various ingredients (e.g., cans, bottles, portions), the user does not have to weigh, type in or input the ingredients they are using. The user can freely cook and move about the kitchen as normal.

In certain embodiments, by cross referencing IoT sensor activity, the cognitive portion and ingredient suggestion operation can determine when ingredients are removed from the refrigerator to help cross reference and improve the probability of the correct ingredient and also identify an ingredient. For example, egg slots in IoT based refrigerators could identify an egg being used as definitive. Opening of a fresh fruit tray of an IoT based refrigerator can indicate likely use of vegetable or fruit in the recipe.

Additionally, in certain embodiments, certain IoT devices can provide size or measurement information which can be used by the cognitive portion and ingredient suggestion operation to provide portion control suggestions based on the items and amounts that are actually used when cooking a particular recipe. In certain embodiments, the portion control suggestions can include information relating to the profile of a user. Additionally, in certain embodiments, the cognitive portion and ingredient suggestion operation is included within a cognitive cooking system which is integrated with IoT sensors and user profiles to identify intended recipes and suggest variations best suited to health and nutritional requirements of one or a plurality of users.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

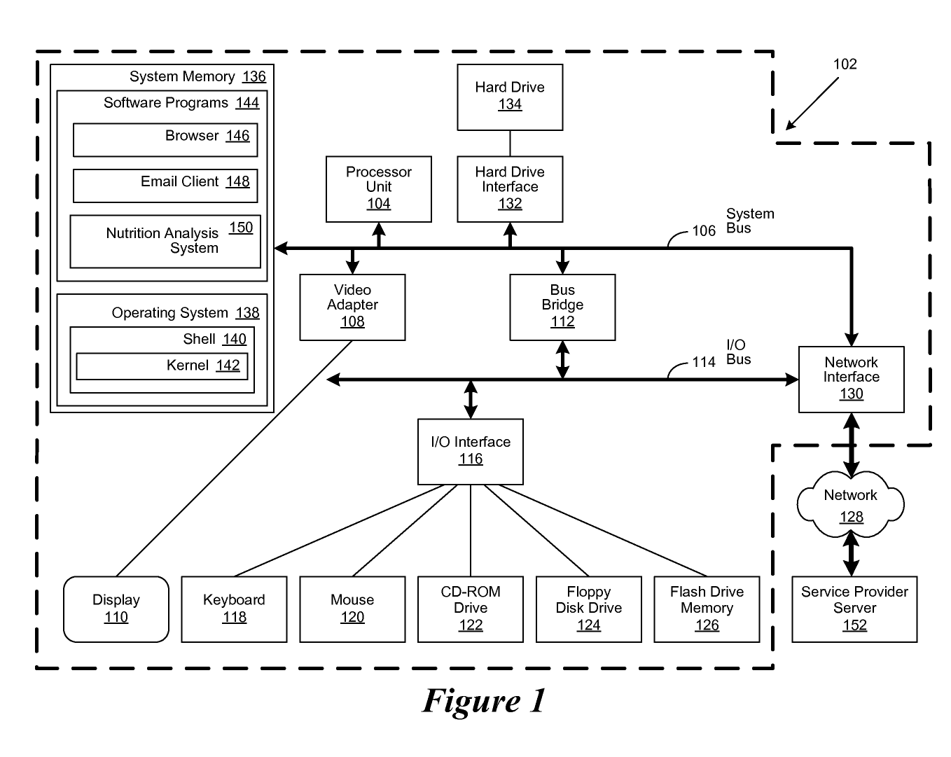

FIG. 1 is a block diagram of an exemplary client computer 102 in which the present invention may be utilized. Client computer 102 includes a processor unit 104 that is coupled to a system bus 106. A video adapter 108, which controls a display 110, is also coupled to system bus 106. System bus 106 is coupled via a bus bridge 112 to an Input/Output (I/O) bus 114. An I/O interface 116 is coupled to I/O bus 114. The I/O interface 116 affords communication with various I/O devices, including a keyboard 118, a mouse 120, a Compact Disk-Read Only Memory (CD-ROM) drive 122, a floppy disk drive 124, and a flash drive memory 126. The format of the ports connected to I/O interface 116 may be any known to those skilled in the art of computer architecture, including but not limited to Universal Serial Bus (USB) ports.

Client computer 102 is able to communicate with a service provider server 152 via a network 128 using a network interface 130, which is coupled to system bus 106. Network 128 may be an external network such as the Internet, or an internal network such as an Ethernet Network or a Virtual Private Network (VPN). Using network 128, client computer 102 is able to use the present invention to access service provider server 152.

A hard drive interface 132 is also coupled to system bus 106. Hard drive interface 132 interfaces with a hard drive 134. In a preferred embodiment, hard drive 134 populates a system memory 136, which is also coupled to system bus 106. Data that populates system memory 136 includes the client computer's 102 operating system (OS) 138 and software programs 144.

OS 138 includes a shell 140 for providing transparent user access to resources such as software programs 144. Generally, shell 140 is a program that provides an interpreter and an interface between the user and the operating system. More specifically, shell 140 executes commands that are entered into a command line user interface or from a file. Thus, shell 140 (as it is called in UNIX®), also called a command processor in Windows®, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. While shell 140 generally is a text-based, line-oriented user interface, the present invention can also support other user interface modes, such as graphical, voice, gestural, etc.

As depicted, OS 138 also includes kernel 142, which includes lower levels of functionality for OS 138, including essential services required by other parts of OS 138 and software programs 144, including memory management, process and task management, disk management, and mouse and keyboard management. Software programs 144 may include a browser 146 and email client 148. Browser 146 includes program modules and instructions enabling a World Wide Web (WWW) client (i.e., client computer 102) to send and receive network messages to the Internet using HyperText Transfer Protocol (HTTP) messaging, thus enabling communication with service provider server 152. In various embodiments, software programs 144 may also include a nutrition analysis module 150. In these and other embodiments, the nutrition analysis module 150 includes code for implementing the processes described herein below. In one embodiment, client computer 102 is able to download the nutrition analysis module 150 from a service provider server 152.

The hardware elements depicted in client computer 102 are not intended to be exhaustive, but rather are representative to highlight components used by the present invention. For instance, client computer 102 may include alternate memory storage devices such as magnetic cassettes, Digital Versatile Disks (DVDs), Bernoulli cartridges, and the like. These and other variations are intended to be within the spirit, scope and intent of the present invention.

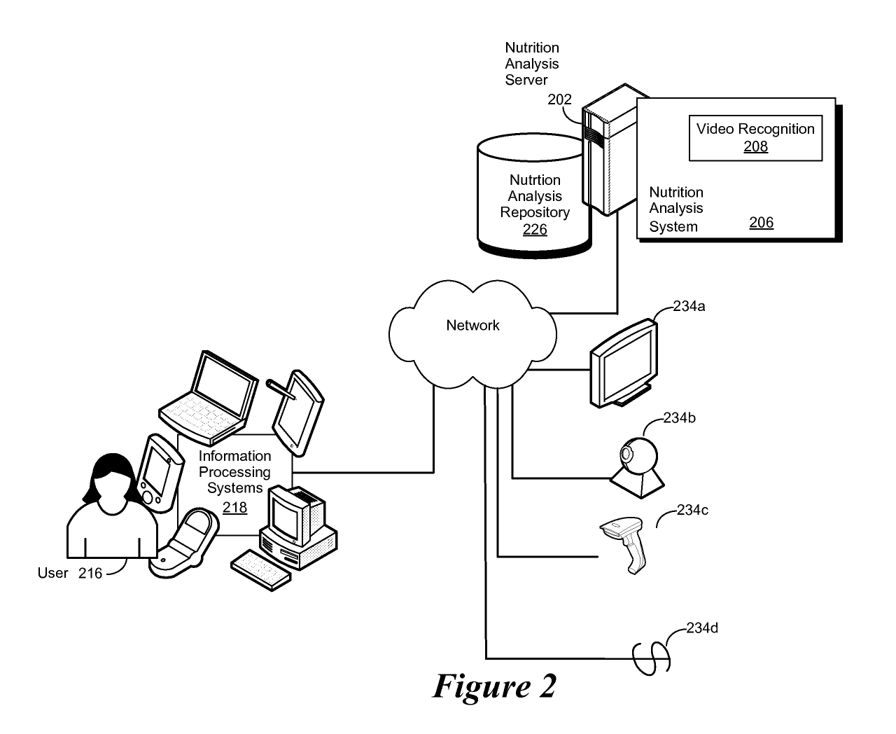

Referring to FIG. 2, a simplified block diagram of an information processing environment 200 having many IoT type devices is shown.

The environment 200 includes a nutrition analysis server 202 which includes a nutrition analysis system 206. In certain embodiments, the nutrition analysis system 206 comprises some or all of the nutrition analysis module 150. In these and other embodiments, a user 216 may use an information processing system 218 to access the nutrition analysis systems 206. As used herein, an information processing system 218 may comprise a personal computer, a laptop computer, or a tablet computer operable to exchange data between the user 216 and the collaboration authorization server 202 over a connection to network 140. The information processing system 218 may also comprise a personal digital assistant (PDA), a mobile telephone, or any other suitable device operable to display a user interface (UI) 220 and likewise operable to establish a connection with network 140. In various embodiments, the information processing system 218 is likewise operable to establish a session over the network 140 with the nutrition analysis system 206.

In various embodiments, nutrition analysis operations are performed by the nutrition analysis system 206 which receive information from one or more devices (such as device 234). In various embodiments, the nutrition analysis operation includes a cognitive portion and ingredient suggestion operation. The nutrition analysis system 206 enables the environment 200 to perform nutrition analysis operations using devices 234 including IoT type devices.

In operation, as a user starts preparing ingredients for a recipe they plan on cooking, a set of sensors (camera, cooktop heat, refrigerator . . . ) track the ingredients used and the settings. Each device 234 may include one or more sensor. Based on the ingredient list, the nutrition analysis operation identifies possible recipes being cooked (from a database of recipes stored within the nutrition analysis repository 226). Given the ingredient list, the recipe, and how it is being cooked, the nutrition analysis operation extracts the nutritional value of the meal and compares against nutritional targets for the users to whom the meal is being prepared.

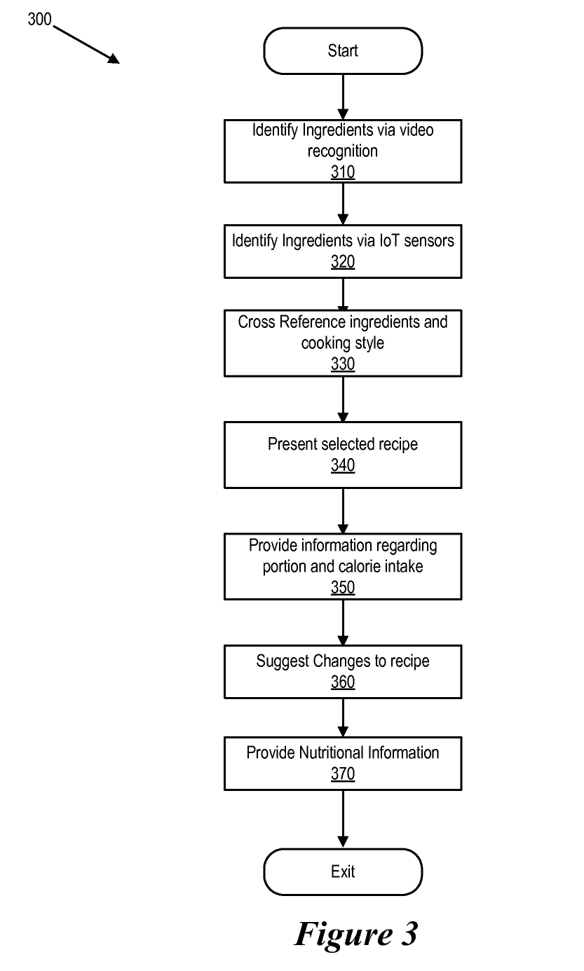

FIG. 3 shows a flow chart of a nutrition analysis operation. More specifically, the nutrition analysis operation begins at step 310 with the nutrition analysis system 206 identifying ingredients being used by the user 216. The ingredients are identified either via video recognition, by performing a scan operation or via one or more IoT type sensors 234. In various embodiments, a camera coupled to the nutrition analysis system 206 generates video information which is then processed by a video recognition module 208 to provide video recognition information. In various embodiments, the nutrition analysis system 206 uses the video recognition information to identify ingredients (e.g., a can of a particular ingredient). The nutrition analysis system 206 then cross references the identified ingredients to recipe amounts. The video recognition information can also enable the nutrition analysis system 206 to identify ingredients being held by a user or when an ingredient is removed from a pantry or cabinet. The video recognition information can also enable the nutrition analysis system 206 to identify when an ingredient is placed in a container for use in recipe preparation. The video recognition information can also enable the nutrition analysis system 206 to identify when an ingredient or combination of ingredients is placed in an oven or on a stovetop.

Next, at step 320, the nutrition analysis system 206 uses IoT type sensors to identify ingredients. For example, in certain embodiments, an IoT type refrigerator sensor could sense the positive use of an item to correlate this use against a video recognition identification. For example an IoT type refrigerator sensor might sense when an egg is removed from an egg container of the IoT type refrigerator. Additionally, in certain embodiments, the IoT type sensor might include a scale that senses a weight change. For category items, the nutrition analysis system 206 can correlate a section of the refrigerator opened with the type of ingredients contained therein, and cross reference the weight change of the items with the potential type of item removed. For example, in certain embodiments the category items might include items stored within certain subsections of the refrigerator such as items stored in a produce drawer or on a particular shelf. In certain embodiments, a weight change analysis can help estimate which item is removed from a subsection. The nutrition analysis system 206 would then cross reference and correlate against video recognition to narrow down the right ingredient. For example, a potato will weigh more than a turnip and dramatically more than leafy lettuce. Correlating the weight information with the video recognition information will increase the effectiveness of the ingredient determination. Additionally, in various embodiments other IoT type sensors are also used to track, incorporate and identify inventory. For example, salt shakers and seasoning holders could also incorporate their own respective IoT type sensors.

Next, at step 330, the nutrition analysis system 206 cross references the identified ingredients along with any identified cooking style of the user 216 to locate potential recipes. In various embodiments, when locating potential recipes, the nutrition analysis system 206 uses video recognition to identify utensils utilized to help identify the potential cooking styles to help cross reference potential recipes. In various embodiments, when locating potential recipes, the nutrition analysis system 206 uses video recognition to cookware such as pots, frying pans, baking dishes, etc. to help identify the potential cooking styles to help cross reference potential recipes. In various embodiments, when locating potential recipes, the nutrition analysis system 206 uses IoT type sensors, such as an IoT sensor located on a cooking device, to sense heat level applied to cooking utensil and temperature and length of time to help identify cooking style. In various embodiments, the nutrition analysis system 206 cross references cooking styles with ingredients and provides the results as an input into a recipe database (which may be included within the nutrition analysis repository 226) to cognitively select a most likely recipe for the particular user 216.

Next, at step 340, the nutrition analysis system 206 presents the selected recipe to the user and provides the user with an option of confirming the recipe as well as providing any potential substitutions that may be possible for the recipe. In various embodiments, the substitutions can include suggestions for ingredient changes to address any known health issues for the user or for individuals associated with the user. Next, at step 350, based on a user profile, the nutrition analysis system 206 provides information regarding the type of portion and calorie intake of the recipe including substitutions that change calorie and fat intake.

Next at step 360, the nutrition analysis system 206 suggests changes to the recipe which may reduce portion intake to maintain calorie intake and fat based on user profile. In certain embodiments, the nutrition analysis system 206 considers cooking style and/or cooking method and as well as ingredients to understand and cross reference the amount of lipids and fats potentially left in the meal based on the amount of time an ingredient is cooked. The nutrition analysis system 206 identifies which of certain ingredients nutrient count may be reduced if over cooked, or increased depending on the cooking method (e.g., flash steam vegetables contain more ingredients, boiled vegetables contains less since they are cooked out in water). Next at step 370, the nutrition analysis system 206 provides nutritional information such as calorie count and nutritional value based on the ingredients used and the recipe, plus portion amount for each individual who is associated with the user (e.g., each individual at the table with the user).

In certain embodiments, the nutrition analysis system 206 performs an analysis of the ingredients as well as the individuals for whom the recipe is being prepared and based on this analysis, suggests variations of the recipe which better match the nutritional needs of the individuals for whom the meal is being prepared.

Taking an example where a chef is cooking Fettucine Alfredo. In one embodiment, a camera in the kitchen generates video recognition information of the ingredients. In another embodiment, the chef scans the ingredients using a scanner that identifies the ingredients based for example on bar code (or qcode). Given the list of ingredients, the nutrition analysis operation identifies the recipe as that of Fettucine Alfredo. Where there could be multiple recipes that use same set of ingredients the nutrition analysis operation would track as many possible recipes as practical.

The nutrition analysis operation then pulls up nutritional information about Fettucine Alfredo recipe from its database (e.g., the nutrition analysis repository 226) and obtains nutritional information like calories, carbs, salts, fat, iron, . . . , and other nutrients of interest. The nutrition analysis operation then compares the extracted nutrient list to that of desired nutrition needs of the end users and identifies any concerns. For example, if the end user has high levels of cholesterol, the nutrition analysis operation might identify that one cup heavy cream and two cups of Parmesan provide more fat than is recommended. Accordingly the nutrition analysis operation would suggest variations to the recipe like for example, using fat-free cream or using less than two cups of cheese.

In another example, consider the scenario where a chef is cooking spinach. After the nutrition analysis operation identifies the recipe, the nutrition analysis operation might indicate that the spinach will be boiled to a high temperature for 25 minutes. The nutrition analysis operation recognizes the need to maximize iron intake based on end user profile and accordingly, looks up in its database what is the best cooking style of spinach to retain most iron (e.g., by flash steaming the spinach) and suggests that to the chef.

Although the present invention has been described in detail, it should be understood that various changes, substitutions and alterations can be made hereto without departing from the spirit and scope of the invention as defined by the appended claims.

What is claimed is:

1. A method for cognitive personalized nutrition analysis comprising:
performing a visual recognition operation to identify ingredients being used by a chef;
analyzing sensor data to identify ingredients being used by a chef;
determining a cooking style based upon the visual recognition operation and the sensor data;
cross referencing ingredients and cooking style to locate potential recipes corresponding to the ingredients and cooking style; and,
notifying the chef of identified recipes and possible substitutions.

2. The method of claim 1, further comprising:
reporting nutritional information to the chef based upon the identified recipes and possible substitutions.

3. The method of claim 1, further comprising:
providing portion and nutrition intake of the recipe including substitutions based on user profiles.

4. The method of claim 1, further comprising:
suggesting variations to at least one of ingredients, portions, and cooking style to take into account nutrition needs of users.

5. The method of claim 1, wherein:
the sensor data is provided by an Internet of Things (IoT) type sensor.

6. The method of claim 1, wherein:
the identified recipes include suggested variations best suited to health and nutritional requirements of a user.

7. A system comprising:
a processor;
a data bus coupled to the processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
performing a visual recognition operation to identify ingredients being used by a chef;
analyzing sensor data to identify ingredients being used by a chef;
determining a cooking style based upon the visual recognition operation and the sensor data;
cross referencing ingredients and cooking style to locate potential recipes corresponding to the ingredients and cooking style; and,
notifying the chef of identified recipes and possible substitutions.

8. The system of claim 7, wherein the instructions are further configured for:
reporting nutritional information to the chef based upon the identified recipes and possible substitutions.

9. The system of claim 7, wherein the instructions are further configured for:
providing portion and nutrition intake of the recipe including substitutions based on user profiles.

10. The system of claim 7, wherein the instructions are further configured for:
suggesting variations to at least one of ingredients, portions, and cooking style to take into account nutrition needs of users.

11. The system of claim 7, wherein:
the sensor data is provided by an Internet of Things (IoT) type sensor.

12. The system of claim 7, wherein:
the identified recipes include suggested variations best suited to health and nutritional requirements of a user.

13. A non-transitory, computer-readable storage medium embodying computer program code, the computer program code comprising computer executable instructions configured for:
performing a visual recognition operation to identify ingredients being used by a chef;
analyzing sensor data to identify ingredients being used by a chef;
determining a cooking style based upon the visual recognition operation and the sensor data;
cross referencing ingredients and cooking style to locate potential recipes corresponding to the ingredients and cooking style; and,
notifying the chef of identified recipes and possible substitutions.

14. The non-transitory, computer-readable storage medium of claim 13, wherein the computer executable instructions are further configured for:
reporting nutritional information to the chef based upon the identified recipes and possible substitutions.

15. The non-transitory, computer-readable storage medium of claim 13, wherein the computer executable instructions are further configured for:
providing portion and nutrition intake of the recipe including substitutions based on user profiles.

16. The non-transitory, computer-readable storage medium of claim 13, wherein the computer executable instructions are further configured for:
suggesting variations to at least one of ingredients, portions, and cooking style to take into account nutrition needs of users.

17. The non-transitory, computer-readable storage medium of claim 13, wherein:
the sensor data is provided by an Internet of Things (IoT) type sensor.

18. The non-transitory, computer-readable storage medium of claim 13, wherein:
the identified recipes include suggested variations best suited to health and nutritional requirements of a user.
